(19) United States
(12) Patent Application Publication
(10) Pub. No.: US 2013/0335551 A1
(43) Pub. Date: Dec. 19, 2013

(54) DEVICE FOR INSPECTING A STEAM GENERATOR

(71) Applicants: Jean-Paul Mandier, Domarin (FR); Jorge De Oliveira, Rochegude (FR); Laurent Fanjas, Rillieux-la-pape (FR)

(72) Inventors: Jean-Paul Mandier, Domarin (FR); Jorge De Oliveira, Rochegude (FR); Laurent Fanjas, Rillieux-la-pape (FR)

(73) Assignee: SRA SAVAC, Vaulx En Velin (FR)

(21) Appl. No.: 14/001,654

(22) PCT Filed: Feb. 24, 2012
(86) PCT No.: PCT/FR2012/050389

§ 371 Date: Aug. 26, 2013

(30) Foreign Application Priority Data
Feb. 25, 2011 (FR) 11/51548

(51) Int. Cl. G21C 17/007; G21C 17/017; G21C 17/01

(52) U.S. Cl. CPC G21C 17/007; G21C 17/01; G21C 17/017
USPC 348/84

(57) ABSTRACT

An inspection device for inspecting a steam generator having a first long and flexible video probe intended to be inserted inside the housing of the steam generator and configured to be moveable through a fluid passage orifice defined by a spacer plate and a flow tube, all arranged inside the housing. The first video probe includes at least one ferromagnetic element. The inspection device also includes a second long and flexible probe to be inserted into a flow tube, the second probe including at least one permanent magnet arranged to cooperate with the at least one ferromagnetic element of the first probe so that the first probe can be driven along the exterior surface of a flow tube by the second probe when the second probe is inserted into the flow tube and moved therein, and when the first probe is inserted into the housing of the steam generator and positioned near the exterior surface of the flow tube in which the second probe is inserted.

### FIELD OF THE INVENTION

The present invention relates to a device for inspecting a steam generator.

### BACKGROUND OF THE INVENTION

Steam generators are in particular used in nuclear power plants, where they form heat exchangers including two distinct circuits, respectively a primary circuit in which hot water circulates at a very high pressure coming from the reactor, and a secondary circuit in which the water is brought to boil. The steam thus formed then escapes from the steam generator and is used to rotate turbines coupled to an alternator.

FIG. 1 shows part of a steam generator 1 assuming the form of a cylindrical housing including a lower portion 2 designed for connection of the primary circuit, and an upper portion 3 designed for the outlet of the steam and drying thereof.

The steam generator 1 includes an outer enclosure called a shroud 4 and an inner enclosure called an enclosure skirt 5. Metal flow tubes 6 are positioned in the volume delimited by the enclosure skirt 5. These are generally in the shape of an upside down U and are designed for the circulation of water from the primary circuit. They then exchange heat with the water from the secondary circuit located inside the enclosure skirt 5. These tubes 6 are mounted, in the lower portion 2, on a support plate called a tubular plate 7 and passing through spacer plates 8 regularly spaced apart from each other and parallel to each other, the latter making it possible to avoid any movement of the tubes 6 with respect to one another. Each spacer plate 8 forms a so-called water flow passage 9, extending diametrically with respect to the spacer plate 8.

The spacer plates 8 include, for the passage of the tubes 6, openings 10 on the one hand providing contact areas with a tube to ensure holding thereof, and the other hand delimiting passage areas for the water or steam from the secondary circuit, depending on the position of the corresponding spacer plate 8. These openings are generally in the shape of crosses or have four leaves such that each opening delimits, with the corresponding tube, four lobes regularly distributed around the tube, said lobes forming the aforementioned passage areas, and generally being called “leafed passages”.

During the operation of a steam generator, water present in the housing of the generator is brought to a high temperature and high pressure in order to generate steam. The tubes and other metal parts of the cyclone separator are then subjected to extreme conditions that inevitably cause corrosion.

Without intervention, deposits related to this corrosion build up on the tubular plate 7 and the spacer plates 8, and may in particular at least partially clog the aforementioned passage areas, which is detrimental to the output of the steam generator, as well as the operating safety thereof if the clogging level reaches a high value.

In fact, a high clogging rate may lead to the appearance of excessive vibrations of the tubes in certain areas of the steam generator, these vibrations potentially leading to the quick development of cracks of the tubes and therefore the appearance of leaks between the primary and secondary circuits.

Such a high clogging rate may also cause oscillation phenomena at the water in the secondary circuit, and significant mechanical forces on the spacer plates, the flow tubes and the inner enclosure.

It is therefore useful to be able to access the connecting areas between the tubes 6 and the spacer plates 8 so as to be able to place an apparatus therein, for example a video probe making it possible to inspect those areas.

In order to inspect the housing of a steam generator, and more particularly at least part of the aforementioned passage areas, it is known to use an inspection system comprising a video probe and a device for inserting a probe as described in document FR 2,914,394.

Such a system allows the monitoring and dimensioning of the clogging of the passage areas of the upper spacer plate, as well as intermediate spacer plates.

However, such an inspection system only makes it possible to view the clogging in the passage areas, from above, but does not make it possible to obtain information on the shape of the clog at the plate inlet, i.e., in the circulation direction of the fluid in the secondary circuit, which may lead to a poor estimate of the clogging level.

The present invention aims to resolve this drawback.

The technical problem at the base of the invention therefore consists of providing a device for inspecting a steam generator that has a simple and cost-effective structure, while allowing effective, easy and quick inspection of the steam generator.

### BRIEF SUMMARY OF THE INVENTION

To that end, the present invention relates to an inspection device for inspecting a steam generator comprising a sealed housing containing a plurality of flow tubes for a first fluid and at least one spacer plate designed to maintain the tubes and having a set of tube passage openings, said housing being designed to receive a second fluid, the inspection device including:

a first long and flexible video probe, designed to be inserted into the housing of the steam generator through an opening thereof and configured to be able to be moved through a fluid passage opening delimited by a spacer plate and a flow tube, the first video probe comprising at least one ferromagnetic element,

a second long and flexible probe, designed to be inserted, through an opening of the housing of the steam generator, into a flow tube, the second probe comprising at least one permanent magnet arranged to cooperate with the at least one ferromagnetic element of the first probe so that the second probe can drive the first probe along the outer surface of a flow tube, when the second probe is inserted into said flow tube and moved therein, and when the first probe is inserted into the housing of the steam generator and positioned near the outer surface of the flow tube in which the second probe is inserted.

Due to the magnetic coupling of the ferromagnetic element(s) of the first probe with the permanent magnet(s) of the second probe, the first probe may be maintained, guided and driven from bottom to top over substantially the entire straight portion of the flow tube, thereby making it possible to access at least one fluid passage opening (called leafed passage) partially delimited by said flow tube, at each spacer plate.

Furthermore, the fact that the first probe can be driven from bottom to top by the second probe makes it possible to position, at the inlet of each spacer plate, televisual images of at least one leafed passage, and therefore the shape of the fouling and the size of the clogged section thereof.

Furthermore, driving the first probe along the outer surface of the flow tube makes it possible to view the fouling thereof.

Consequently, by performing successive inspections along several preselected flow tubes, it is possible to obtain a better estimate of the clogging level, and therefore to avoid the drawbacks of the devices of the prior art.

Preferably, the second probe includes, near its distal end, a permanent magnet having at least one planar face extending by an angle smaller than 45° with respect to the general direction of the second probe, and preferably substantially parallel to the general direction of the second probe, and rotational means arranged to rotate said permanent magnet around an axis substantially parallel to the general direction of the second probe. These arrangements make it possible to realign the first probe at a reference leafed passage in case of vertical drift during the mounting of the first probe, or to orient the first probe at the leafed passages adjacent to the reference leafed passage so as to be able to view them.

Preferably, the permanent magnet having at least one planar face is parallelepiped, and for example has a square section.

Advantageously, the permanent magnet having at least one planar face includes a longitudinal axis extending substantially in the general direction of the second probe, and the rotational driving means are arranged to rotate said permanent magnet around its longitudinal axis.

The rotational driving means for example include an electric motor whereof the output shaft is rotationally coupled with the permanent magnet having at least one planar face. The output shaft may be coupled directly in rotation with said permanent magnet, or may be coupled in rotation with a support member, such as a flange, secured in rotation with said permanent magnet.

Preferably, the second probe includes a plurality of permanent magnets longitudinally offset with respect to each other, and the first probe includes a plurality of ferromagnetic elements longitudinally offset relative to one another, each ferromagnetic element being arranged to cooperate by magnetic coupling with one of the permanent magnets of the second probe. These arrangements make it possible to ensure optimized guiding and driving of the first probe by the second probe.

According to one embodiment of the invention, the permanent magnets distinct from the permanent magnet having at least one planar face are substantially cylindrical and preferably have a circular section.

Preferably, the second probe includes a plurality of spacers each positioned between two adjacent permanent magnets distinct from the permanent magnet having at least one planar face.

Preferably, the or each ferromagnetic element includes a ferromagnetic ring mounted on the outer surface of the first probe.

According to one embodiment of the invention, the first probe includes lighting means arranged to light an area positioned near the distal end of the first probe.

Advantageously, the lighting means include at least one first optical fiber comprising a first end connected to a light source and a second end emerging at the distal end of the first probe.

Preferably, the first probe is a fiberscope.

According to one embodiment of the invention, the first probe includes air propulsion means arranged to propel the air near or at the distal end of the first probe. Such air propulsion means in particular make it possible to clean the video lens of the first probe. The air propulsion means for example include a capillary extending substantially over the entire length of the first probe and connected to a compressed air source.

Advantageously, the inspection device includes first insertion and positioning means for inserting and positioning the first probe inside the housing of the steam generator, comprising:

a support rail designed to be inserted, through an opening of the housing of the steam generator, in a substantially horizontal insertion direction between two rows of flow tubes,

guiding and maintaining means designed to be fastened at said opening of the enclosure and arranged to guide and maintain the support rail in the insertion direction,

a wagon mounted movably on the support rail and provided with a multidirectional head,

a flexible hose including a first end portion mounted on the multidirectional head of the wagon, and a second end portion designed to protrude outside the steam generator, the first video probe being designed to be inserted and moved inside the flexible hose,

scanning means arranged to move the multidirectional head of the wagon in at least one first direction transverse to the insertion direction, and

translational movement means arranged to translate the wagon along the support rail.

The scanning means are for example arranged to rotate the multidirectional head so as to allow it to oscillate around the pivot point.

Advantageously, the inspection device comprises second insertion and positioning means for inserting and positioning the second probe inside the housing of the steam generator, including:

first and second support rails designed to be fastened on the inner face of the support plate such that they extend substantially parallel to each other,

a third support rail translatably mounted on the first and second support rails parallel to their extension direction,

a wagon movably mounted on the third support rail,

a guide sheath including a first end portion mounted on the wagon and a second end portion designed to protrude outside the steam generator, the second probe being designed to be inserted and moved inside the guide sheath, and

first and second movement means arranged to move the third support rail and the wagon mounted thereon so as to position the first end portion of the guide sheath across from a fluid flow passage formed in the support plate and in which a flow tube emerges.

Preferably, the inspection device comprises second probe driving means arranged to move the second probe inside the flow tube.

The second probe driving means for example include at least two rollers, with substantially parallel axes, positioned substantially across from each other and spaced so as to define a probe passage, each roller bearing against the probe and at least one of the rollers being motorized. According to one embodiment of the invention, the driving means are mounted on a winder on which the second probe is designed to be wound.

### BRIEF DESCRIPTION OF THE DRAWINGS

The invention will be well understood using the following description done in reference to the appended diagrammatic drawing showing, as a non-limiting example, one embodiment of this inspection device.

FIG. 1 is a partial cross-sectional view of a traditional steam generator.

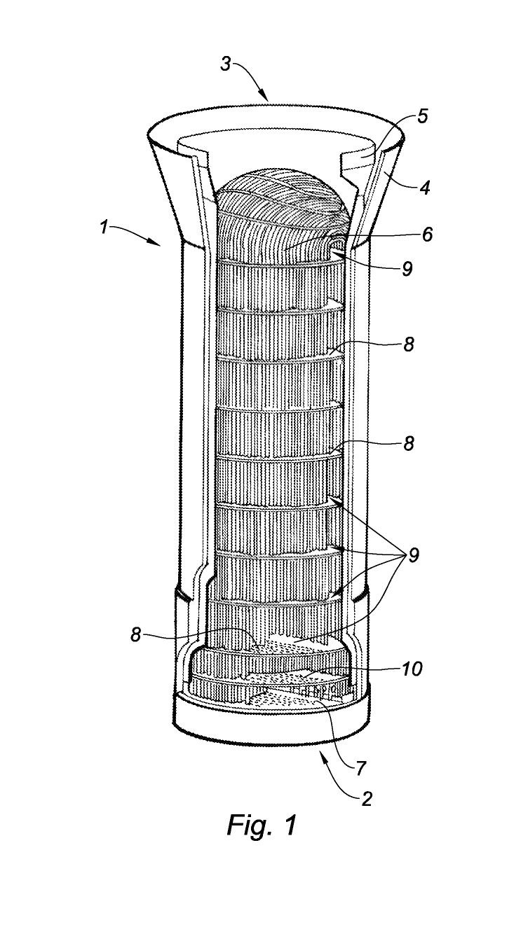

FIG. 2 is a partial perspective view of the inspection device according to the invention.

FIG. 3 is an enlarged partial top view of the inspection device of FIG. 2.

FIGS. 4 and 5 are partial perspective views of the inspection device of FIG. 2 in two different operating positions.

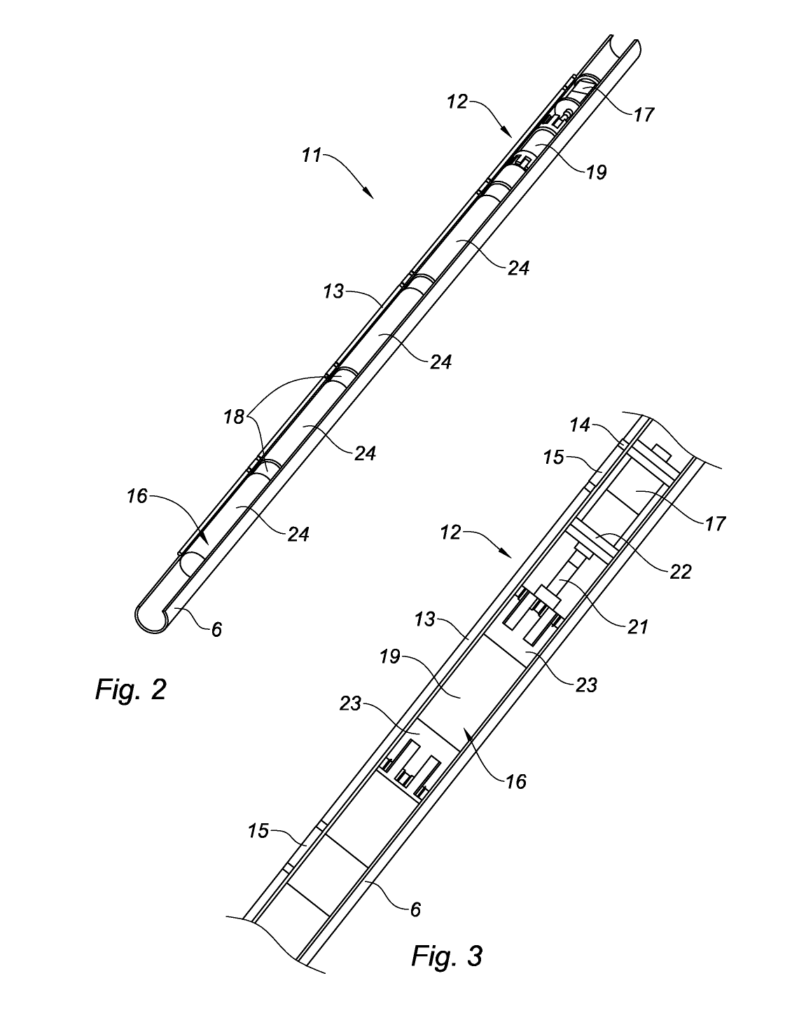

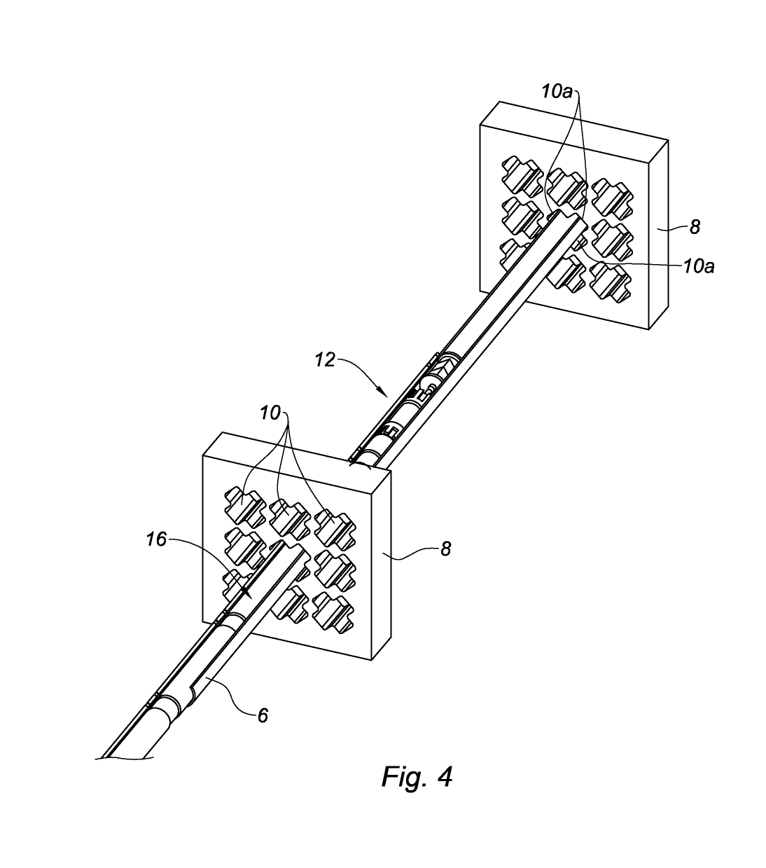

FIGS. 2 to 5 show an inspection device 11 for inspecting a steam generator 1 of a nuclear power plant.

### DETAILED DESCRIPTION OF THE INVENTION

The inspection device 11 includes a first long and flexible video probe 12. The first video probe 12 is advantageously a fiberscope, and for example has a diameter of approximately 2 mm. The first video probe 12 comprises an outer sheath 13 at the distal end of which a head 14 is mounted equipped with a video lens (not shown in the figures). The first video probe 12 further comprises lighting means (not shown in the figures) arranged to light an area positioned near the distal end of the first probe.

The lighting means advantageously include at least one optical fiber or optical fiber bundle extending inside the outer sheath 13 substantially over the entire length thereof. The or each optical fiber includes a first end connected to a light source (not shown in the figures) and a second end emerging at the distal end of the first probe.

The second end of the or each optical fiber is preferably oriented so as to cause the light from the light source to converge in an area substantially corresponding to the detection area of the lens.

According to one alternative embodiment of the invention, the second end of the or each optical fiber may be connected to a light diffusion device.

The first video probe 12 further comprises a second optical fiber arranged to convey the image provided by the lens to a display device so as to allow a user to observe the image provided by the lens.

The first probe also includes a plurality of ferromagnetic elements 15 longitudinally offset from one another by a predetermined distance. Each ferromagnetic element is advantageously made up of a ferromagnetic ring mounted around the outer sheath 13 of the first probe 12.

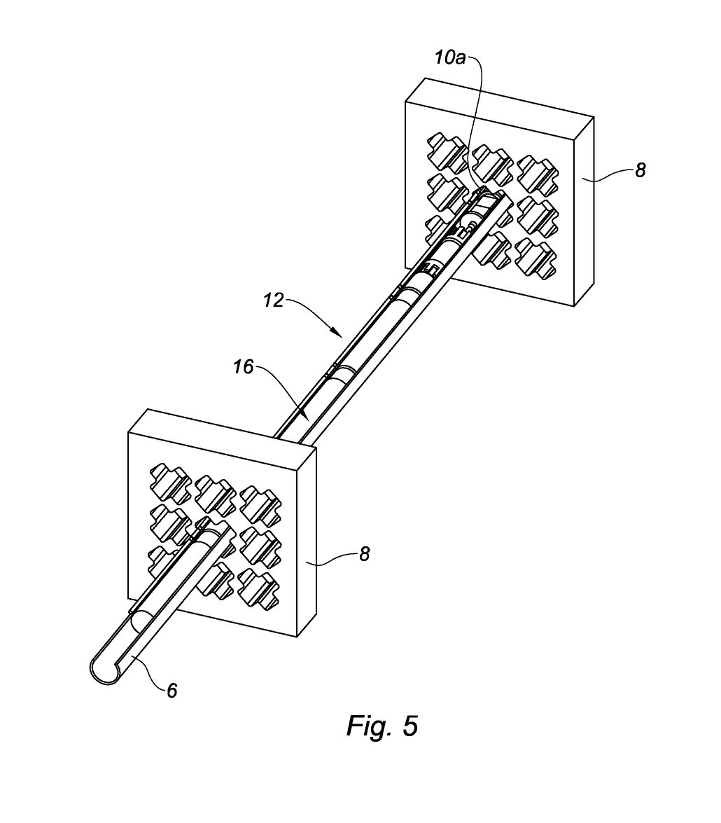

The first video probe 12 is designed to be inserted into the housing of the steam generator 1 through an opening thereof, such as a hand or eye hole, and is configured to be movable through a fluid passage opening 10a delimited by a spacer plate 8 and a flow tube 6, as shown in FIGS. 4 and 5.

The inspection device 11 also includes a second long and flexible probe 16. The second probe 16 on the one hand comprises an outer sheath (not shown in the figures), and on the other hand a plurality of permanent magnets housed in the outer sheath longitudinally offset with respect to one another by a predetermined distance.

The second probe 16 more particularly comprises a permanent magnet 17 of the first type positioned near the distal end of the second probe, and a plurality of permanent magnets 18 of the second type.

The permanent magnet 17 of the first type is preferably parallelepiped, and advantageously has a square section. The permanent magnet 17 of the first type is positioned inside the outer sheath such that its four side faces extend substantially parallel to the general direction of the second probe 16.

The permanent magnets 18 of the second type are substantially cylindrical and have a circular section. The longitudinal axis of each permanent magnet 18 of the second type extends substantially in the general direction of the second probe 16.

The second probe 16 further comprises rotational driving means arranged to rotate the permanent magnet 17 of the first type around the longitudinal axis. The rotational driving means for example include an electric motor 19 whereof the output shaft 21 is coupled in rotation with a support flange 22 secured in rotation to the permanent magnet 17 of the first type.

The second probe 16 also comprises centering means 23 arranged so as to center the output shaft 21 of the motor 19 on the longitudinal axis of the permanent magnet 17.

The second probe 16 additionally includes a plurality of substantially identical spacers 24 each positioned between two adjacent permanent magnets 18 of the second type.

The second probe 16 is designed to be inserted, through an opening of the housing of the steam generator, such as the water inlet or outlet of the primary circuit, into a flow tube 6.

Each permanent magnet 17, 18 of the second probe 16 is arranged to cooperate by magnetic coupling with one of the ferromagnetic elements 15 of the first probe 12 so that the second probe 16 drives the first probe along the outer surface of the flow tube, when the second probe is inserted into said flow tube and moved therein, and when the first probe 12 is inserted into the housing of the steam generator and positioned near the outer surface of the flow tube in which the second probe is inserted.

The inspection device 11 further comprises first insertion and positioning means (not shown in the figures) for inserting and positioning the first probe 12 inside the housing of the steam generator.

The first insertion and positioning means preferably include:

a support rail designed to be inserted, through an opening of the housing of the steam generator, such as a hand or eye hole, in a substantially horizontal insertion direction between two rows of flow tubes 6,

guiding and maintaining means designed to be fastened at said opening of the enclosure and arranged to guide and maintain the support rail in the insertion direction,

a wagon mounted movably on the support rail and provided with a multidirectional head,

a flexible hose including a first end portion mounted on the multidirectional head of the wagon, and a second end portion designed to protrude outside the steam generator, the first video probe 12 being designed to be inserted and moved inside the flexible hose,

scanning means arranged to move the multidirectional head of the wagon in at least one first direction transverse to the insertion direction, and

translational movement means arranged to translate the wagon along the support rail.

The first insertion and positioning means are arranged to allow an operator to easily position the distal end of the first probe 12 near the outer surface of a flow tube 6, and preferably on a generatrix of the outer surface thereof, on the one hand by moving the wagon along the support rail and orienting the multidirectional head so as to position the distal end of the flexible hose near the desired winding tube, and on the other hand by moving the first probe 12 inside the flexible hose.

According to one embodiment of the invention, the scanning means are arranged to rotate the multidirectional head so as to allow it to oscillate around a pivot point.

The inspection device 11 advantageously comprises means (not shown in the figures) for driving the first probe 12 arranged to move the first probe inside the flexible hose.

The inspection device 11 further comprises second insertion and positioning means (not shown in the figures) for inserting and positioning the second probe 16 inside the housing of the steam generator.

The second insertion and positioning means preferably include:

first and second support rails designed to be fastened on the inner face of the support plate such that they extend substantially parallel to each other,

a third support rail translatably mounted on the first and second support rails parallel to their extension direction,

a wagon movably mounted on the third support rail,

a guide sheath including a first end portion mounted on the wagon and a second end portion designed to protrude outside the steam generator, the second probe 16 being designed to be inserted and moved inside the guide sheath, and

first and second movement means arranged to move the third support rail and the wagon mounted thereon so as to position the first end portion of the guide sheath across from a fluid flow passage formed in the support plate and in which a flow tube emerges.

The inspection device 11 advantageously comprises means (not shown in the figures) for driving the second probe 16 arranged to move the second probe inside a flow tube.

The means for driving the second probe for example include at least two rollers, with substantially parallel axes, positioned substantially across from one another and spaced apart so as to define a probe passage, each roller bearing against the probe and at least one of the rollers being motorized. According to one embodiment of the invention, the means for driving the second probe are mounted on a winder on which the second probe is designed to be wound.

The method for inspecting the steam generator 1 using the inspection device 11 according to the invention will now be described.

The inspection method comprises the following steps:

a) inserting the second probe 16 into the water inlet or outlet of the primary circuit of the steam generator,

b) inserting the distal end of the second probe 16 into a fluid flow passage formed in the support plate 7 in which a preselected flow tube 6 emerges,

c) moving the second probe 16 in said flow tube 6 until its distal end is at a predetermined level substantially corresponding to that of a hand or eye hole formed in the housing of the steam generator,

d) inserting the first probe 12 into the aforementioned hand or eye hole,

e) positioning the distal end of the first probe 12 near the outer surface of said flow tube 6,

f) having the permanent magnet 17 of the second probe 16 cooperate with the ferromagnetic elements 15 mounted near the distal end of the first probe 12,

g) moving the second probe 16 in the flow tube 6 so as to drive the first probe 12 along the outer surface of the flow tube 6 (see FIGS. 4 and 5) in order to view at least one leafed passage partially delimited by said flow tube, at each spacer plate 8.

According to one alternative embodiment of the method, the latter includes a step consisting of rotating the permanent magnet of the first type so as to rotate the distal end of the first probe 12 around the flow tube 6 in order to align the distal end of the latter across from the leafed passage to be analyzed, or to view the different leafed passages delimited by each spacer plate 8 and the flow tube 6. Such a step is advantageously carried out when the head of the first probe 12 is situated near a spacer plate 8, for example at 10 cm or less therefrom.

Advantageously, steps a) to c) are carried out using the second insertion and positioning means, and steps d) and e) are carried out using the first insertion and positioning means.

According to one alternative embodiment of the method, the latter includes a step prior to step g) consisting of rotating the permanent magnet 17 so as to rotate the distal end of the first probe 12 around the flow tube 6, in order to ensure perfect magnetic coupling between the permanent magnet 17 and the ferromagnetic element 15 mounted near the distal end of the first probe 12. Such coupling is verified through the movement of the image provided by the first probe 12.

The invention is of course not limited solely to the embodiments of this inspection device described above as examples, but on the contrary encompasses all alternative embodiments thereof.

1. An inspection device for inspecting a steam generator comprising a sealed housing containing a plurality of flow tubes for a first fluid and at least one spacer plate designed to maintain the tubes and having a set of tube passage openings, said sealed housing being designed to receive a second fluid, the inspection device including:
a long and flexible first video probe, designed to be inserted into the housing of the steam generator through an opening thereof and configured to be able to be moved through a fluid passage opening delimited by a spacer plate and a flow tube, the first video probe having at least one ferromagnetic element,
a long and flexible second probe, designed to be inserted, through an opening of the housing of the steam generator, into a flow tube, the second probe comprising at least one permanent magnet arranged to cooperate with the at least one ferromagnetic element of the first probe so that the second probe can drive the first probe along the outer surface of a flow tube, when the second probe is inserted into said flow tube and moved therein, and when the first probe is inserted into the housing of the steam generator and positioned near the outer surface of the flow tube in which the second probe is inserted.

2. The inspection device according to claim 1, wherein the second probe includes, near its distal end, a permanent magnet having at least one planar face extending by an angle smaller than 45° with respect to the general direction of the second probe, and preferably substantially parallel to the general direction of the second probe, and rotational means arranged to rotate said permanent magnet around an axis substantially parallel to the general direction of the second probe.

3. The inspection device according to claim 2, wherein the permanent magnet having at least one planar face includes a longitudinal axis extending substantially in the general direction of the second probe, and the rotational driving means are arranged to rotate said permanent magnet around its longitudinal axis.

4. The inspection device according to claim 1, wherein the second probe includes a plurality of permanent magnets longitudinally offset with respect to each other, and in that the first probe includes a plurality of ferromagnetic elements longitudinally offset relative to one another, each ferromagnetic element being arranged to cooperate by magnetic coupling with one of the permanent magnets of the second probe.

5. The inspection device according to claim 4, wherein the permanent magnets distinct from the permanent magnet having at least one planar face are substantially cylindrical and preferably have a circular section.

6. The inspection device according to claim 1, wherein the or each ferromagnetic element includes a ferromagnetic ring mounted on the outer surface of the first probe.

7. The inspection device according to claim 1, wherein the first probe includes lighting means arranged to light an area positioned near the distal end of the first probe.

8. The inspection device according to claim 1, wherein the first probe is a fiberscope.

9. The inspection device according to claim 1, further including first insertion and positioning means for inserting and positioning the first probe inside the housing of the steam generator, the first insertion and positioning means comprising:
a support rail designed to be inserted, through an opening of the housing of the steam generator, in a substantially horizontal insertion direction between two rows of flow tubes,
guiding and maintaining means designed to be fastened at said opening of the enclosure and arranged to guide and maintain the support rail in the insertion direction,
a wagon mounted movably on the support rail and provided with a multidirectional head,
a flexible hose including a first end portion mounted on the multidirectional head of the wagon, and a second end portion designed to protrude outside the steam generator, the first video probe being designed to be inserted and moved inside the flexible hose,
scanning means arranged to move the multidirectional head of the wagon in at least one first direction transverse to the insertion direction, and
translational movement means arranged to translate the wagon along the support rail.

10. The inspection device according to claim 1, further including second probe driving means arranged to move the second probe inside a flow tube.
